(19) United States
(12) Patent Application Publication
(10) Pub. No.: US 2010/0013346 A1
(43) Pub. Date: Jan. 21, 2010

(54) LOW SPEED, PERMANENT MAGNET BRUSHLESS MOTORS AND GENERATORS

(76) Inventor: Joseph Peek, Wildwood, FL (US)

Correspondence Address: MOTS LAW, PLLC, 1629 K STREET N.W., SUITE 602, WASHINGTON, DC, 20006-1635, US

(21) Appl. No.: 12/504,321

(22) Filed: Jul. 16, 2009

Related U.S. Application Data
(60) Provisional application No. 61/082,415, filed on Jul. 21, 2008.

(51) Int. Cl. H02K 1/14; H02K 23/44; H02K 1/28

(52) U.S. Cl. 310/216.007; 310/209; 310/156.08

(57) ABSTRACT

Low speed permanent magnet brushless motors and generators are described that employ an internal or external rotor in a radial form with a high or variable rotor pole to stator pole ratio. The devices incorporate multiple stators joined with parallel connections, which provides high efficiency and variable torque. Methods of construction, materials and uses are presented.

### CROSS REFERENCE TO RELATED APPLICATIONS

This application claims priority based on 35 USC 120 from prior U.S. provisional patent application No. 61/082,415 filed on Jul. 21, 2008, entitled “LOW RPM, EXTERNAL ROTOR MOTORS AND GENERATORS”, the entire contents of which are incorporated herein by reference.

### FIELD OF THE INVENTION

The invention relates generally to permanent magnet brushless motors and generators and more particularly to those operating at low shaft speeds, using high pole counts, with high torque and efficiency.

### BACKGROUND OF THE INVENTION

Presently limited and costly fuel recourses and an ever-growing demand for electrical power create a great need for more efficient alternative energy driven generators and their counter parts, improved motors for industry, transportation and consumers. Direct drive technologies hold the most promises in these fields because they eliminate the cost, complexity and efficiency losses incurred by gearboxes and other speed changing equipment. Permanent magnet motors and generators can answer much of what is required, as they are simple and robust in construction, highly efficient and adaptable in a broad range of applications.

What is required of motors is to operate effectively at the speed and torque required of the device and generators must produce electricity effectively and at the velocity, and force levels present in natural sources.

### SUMMARY OF THE INVENTION

Methods and embodiments are described that unite several concepts. A first is the use of multiple stators in conjunction with an expanded rotor. Second, is connection of the multiple stators with each other through like phase parallel connections. Third, some of the stators are made movable, thus allowing their adjustment or retraction from the influence of the rotor. Additionally, the rotor attains a higher than normal ratio of rotor poles when compared with any traditional permanent magnet devices. The embodiments derived from the methods disclosed can be constructed using well-understood and economical tools and materials.

More specifically, an embodiment provides a multiphase, permanent magnet, exterior rotor, brushless apparatus, comprising: a complete stator assembly constructed from multiple identical stators wherein each identical stator is fabricated from permeable steel laminations and wound using a insulated copper wire providing electrical phases and is positioned facing the rotor via an air gap; and a single enlarged rotor attached to a central shaft with bearings and that rotates about the complete stator assembly, the rotor containing a plurality of alternating magnetic poles that face the complete stator via said air gap, wherein the multiple stators are constructed identically and operate simultaneously; and each stator's like phase outputs are connected in parallel with that of the other stators.

### BRIEF DESCRIPTION OF THE DRAWINGS

FIG. 1 shows a motor embodiment with an expanded rotor and base motor.

FIG. 2 is a diagram of individual stators combined in parallel.

FIG. 3 shows a representative odd form motor.

FIG. 4 shows an odd form motor with both interior and exterior stators.

FIG. 5 shows an embodiment of a linear motor.

FIG. 6 shows an interior rotor embodiment with retractable stators.

FIG. 7 shows stator module laminations.

The figures omit bearings, center shaft, inner hub and outer housing, along with the wiring scheme for clarity and their lack of relevance in the description. Rotor pole magnets are depicted in black for inwardly facing north poles and white for inwardly facing south poles. Individual stator phase connections are shown as the letters a, b or c in a circle and combined like phase parallel connections as A, B and C in a square. Air gaps are not shown to scale. In all the figures and embodiments a common 3 phase, 12 stator pole, 14 magnet pole rotor motor is used as an example and for reference only while applying the methods disclosed.

### DETAILED DESCRIPTION

Without wishing to be bound by any one theory for operation of the invention, several technical features were found particularly useful separately and in various combinations, namely:
1. Multiple stators.
2. Like phase parallel connections between stators or groups of stators.
3. A non-traditional arrangement stator or a stator that occupies less than the full 360-degree available circumference.
4. An expanded or enlarged rotor that allows proper electromagnetic interaction with more than one stator.

In particular, combinations of at least the first two elements provided particularly useful devices. The devices may be implemented in many forms and are potent manipulations of the physical and electromagnetic properties of permanent magnet devices and were found useful in a large variety of commercial fields.

Multiple stators are known in several forms both as radial devices with an inner and outer stator mounted about a radial rotor and axial devices using a central disk rotor with round, flat stators mounted on either side. These take full advantage of the exposed north and south poles of the rotor magnets and incorporate parallel connections between the two stators improving performance while reducing winding resistance. Some of the axial versions are capable of adjusting the air gap between the rotor and stators to vary the performance of the motor. These both advance performance and efficiency but use a rotor to stator pole ratio bound by the traditional arrangement thus limiting the overall pole ratios and the number of mountable stators to two. By applying the disclosed methods both types could be improved, yielding greater torque thru the increase in commutations per revolution and efficiency by way of the added number of parallel connections between stators lowering internal resistance further.

The term “traditional arrangement” refers to any stators whose poles are symmetrically or evenly disposed about the full 360-degree area allowed. This traditional arrangement physically limits the space of the rotor and its poles in the device. Speaking generally this arrangement is compact but limits performance and controls the ratios of all similar devices radial and axial. This oldest of traditions, a circle inside a circle separated by the air gap at times can becomes a hindrance to the designer.

A second group of multiple stator PM devices are aircraft generators. These devices create a redundant capability in case of a failure by mounting two or more stators about a single rotor. In Masterman U.S. Pat. No. 4,780,634 these devices continue to improve using methods to lessen iron loss thru bridging between stators. Drawings and text describe a 3-phase generator with external stators and an internal rotor. The overall rotor pole to stator pole ratio is relatively normal at 1/1 but noteworthy is that operationally the ratio is 2/1 and exceeds the traditional arrangement. The net effect of a 2/1 ratio is that the rpm/V of the active stator was lowered and torque was increased by virtue of the added rotor poles passing the stator in a given revolution and was adjusted for no doubt, by the designer in the winding scheme.

This type of device is constrained by end use, but establishes the general configuration without taking the advantages to be gain by the many stators not kept separate, but connected together at the like phases in parallel or the value of a greatly expanded rotor because they were not within the scope of the application. Nowhere in the text or diagrams in this or earlier work by the inventor in regards to these devices are parallel connections between the stators or even the fact that the device could be operated as a motor either mentioned or claimed. As this is an evolutionary development from single-phase devices designed to meet a narrow requirement the art fails to capture or teach the benefits of the configuration.

Additionally known are the advanced designs of Caamano. Latest is U.S. Pat. No. 7,358,639 and is described as a High Frequency Electric Motor or Generator. Here methods and embodiments describe devices constructed from an advanced group of materials using difficult and expensive processes and incorporate at times a greatly increased rotor pole ratio with a single non-traditional arrangement stator. The similarities to some of the present embodiments being disclosed are visual only as all other aspects described and claimed demonstrate vast differences between the two. The largest difference is first in the materials of the core, which are required to be a thin film soft magnetic material or an amorphous metal, none of which is required in the present invention. Different again, are the preferred shapes, structures and arrangements for the plurality of independent electromagnetic assemblies themselves. The copper wire wound stators of the present invention are conventional in material and their stacked lamination typical.

Furthermore, the specific methods of stator pole group wiring and commutation differ greatly from that described herein. In particular, absent are the necessary like phase parallel connections between stators of the present invention. Lastly, as all descriptions and diagrams use series connections between stator poles to establish phases it is clear the arrangement produces a single stator not multiple stators. Though it may be possible to separate the dual pole stator assemblies described in embodiments in some way and operate them in conjunction with the dual segment rotor, this change would still only produce a two-stator device and therefore it is similar but very different.

Finally to be noted, are selected pole paired and pole changeable technologies. The latest of these are found in Broadway U.S. Pat. No. 4,138,619 and Auinger U.S. Pat. No. 4,284,919. These are wiring diagrams utilizing many parallel and series connected groups of stator poles to form high pole count motors and generators. These use, in some cases, tiered groups of parallel connections and series groupings through the delta and wye point connections along with, at times, the changing of terminal connections to effectively, create two speed motors, balance windings, while basic pole pairing lower rpm/V, reduce resistance in the wiring, lower frequency and produces torque.

These treatments, in effect, isolate pole groups or pole pairs in a similar way as in using multiple stators but are limited first, in that they use the traditional arrangement of rotor and stator. Additionally, the wiring diagrams define the interconnections from each stator pole to the eventual output terminals and differ greatly at this point as all multiple stators employed in embodiments may use any functional single or multiphase wiring scheme and pole count to form the individual stator and each stator's outputs are always connected to each other in a like phase parallel manner.

Applying the disclosed methods, the designer is given the flexibility and versatility needed to meet the goals set out previously, starting with the rotor/first stator relationship. The rotor in all embodiments can be as large and contain as many magnet poles as is needed in the overall design. The magnet poles size and spacing if spacing is required, along with the rotor to stator pole ratio, is set by the first stator placed in proximity to the rotor as all other stators are duplicates and act identically and simultaneously.

This identical and simultaneous operation with the first stator by all other subsequent stators is created by the parallel connection between all common output phases.

In another aspect of embodiments is that the rotor and first stator establish the commutation sequence, frequency, rpm/V, basic torque and other motor constants at their joining. While added stators act advantageously to multiply and divide some constants, other constants are left unchanged. Simply put, with each stator added the torque of the first stator is multiplied, its wiring resistance is divided and the remaining constants are left unchanged. This makes it possible to tailor a low speed PM device for the application in new and versatile ways.

In yet another aspect of embodiments, though most advantageous in generators, is that in asymmetrical devices some added stators may be made adjustable with regards to the rotor and air gap or be retractable all together from the influence of the rotor. That is to say, in embodiments where multiple stators takes up less than the full 360-degree area allowed, a space is created making it possible to by various means move, adjust or retract some of the stators and modify the torque characteristics of the device while operating. This may also include disconnecting the stator from the common phase parallel connections. This configuration provides a benefit in that it allows a method of load or speed control for a generator. That is by moving stators into position and connecting the phases, load is increased in increments and slows the system, while retracting a stator and disconnecting it has the reverse effect.

As this overall stator configuration is a manipulation of forces for a particular advantage it is also a compromise with some cost. That cost being in an iron loss and is why radial motors and generators with either an internal or external rotor are the preferred embodiments. This choice provides an open framework structure for simple cooling and room for minimizing or mitigating the heat associated with the loss. The two main sources of heat in all devices are wiring resistance and iron loss and as will be seen the methods disclosed greatly lower this resistance and the heat associated with it. It is believed that operating at low rpm, that is less than 1000 rpm, with a very low IR loss and open structure will work to balance the iron loss without any other cooling needed.

In a further common aspect with embodiments, no special wiring schemes are required beyond that the stators like phase outputs be connected in parallel. That is to say any functional single or multi-phase wiring scheme and stator pole count maybe used to create a stator. Although a motor or generator constructed using the methods described can be modeled and designed from the beginning as a new device, the methods flexibility make it useful in adapting successful existing designs. The term “motor or generator” reflects the fact that an apparatus as described herein can work alternately as a motor and also as a generator depending on how used. For this reason, the term “apparatus” for purposes of this disclosure and the claims, shall mean “motor or generator.”

A “single rotor” in embodiments is a rotor that is large enough to accommodate one or more stators so that each can operate in a normal fashion to assert rotational movement by electromagnetic interaction between it and a stator(s) or, in the case of a generator, produce an electromagnetic interaction between a “single rotor” able to accommodate one or more stators so that each can operate in a normal fashion. In practical terms, the low limit for the number of magnets is twice that of the number of stator poles in the device. The common rule for magnets in a rotor is that they must be arranged in a continuous north, south pattern so when increasing magnets this pattern must be maintained. The number of magnets added over the minimum may be in some multiples or in increments of two, as the rotor is no longer bound to the stator pole count.

In desirable embodiments, design goals for rpm and torque are achieved by increasing the diameter and magnet count of the rotor and operating multiple stators within it. While these methods enlarge the device as a whole, they do not require the scale of the components to be altered to increase torque and lower rpm, only fitted to the enlarged diameter of the new device. As the diameter increase so does added torque from the change in acting arm length. Effectively, this means a change in proportions for the motor in general, from being longer in length than in diameter to being larger in diameter then in length.

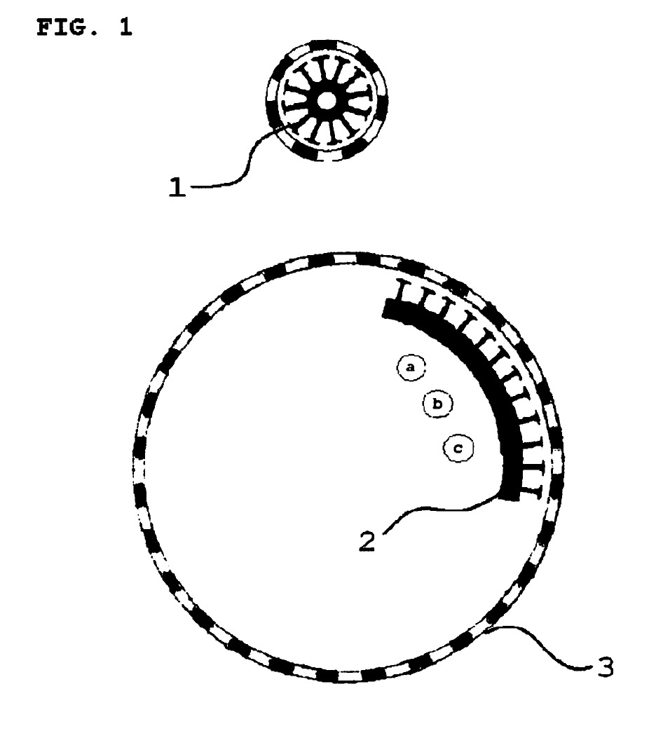

The following table provides some examples of desirable stator pole to rotor pole ratios contemplated, and the resulting commutation per revolution. Some of the conditions in this table are impossible for a “traditional arrangement” motor/generator to achieve. What can be seen is that the stator pole to rotor pole ratio is no longer bound one to the other and that more accurately one stator pole count may have a great many and very high rotor pole ratio options. All the data in the table is based on the reference example motor in row 1 and is depicted as (1) at the top of FIG. 1. Row 2 and 4 are asymmetrical devices with an enlarged rotor. That is to say they use only a single stator to form the complete device and occupy only a portion of the circumference available and the associated rotor is many times larger than a similar conventional motor. Rows 1, 3 and 5 are symmetrical motors or generators with 3 and 5 using multiple stators to form the complete stator and occupy the full 360-degree area available. Rows 2 and 3 show no effect on the number of commutations per revolution yet 3 has 4 times as many stator poles.

| | Stator | Total Stator | Rotor | Commutations per |
|---|---|---|---|---|
| 1 | 1 | 12 | 14 | 42 |
| 2 | 1 | 12 | 56 | 168 |
| 3 | 4 | 48 | 56 | 168 |
| 4 | 1 | 12 | 140 | 420 |
| 5 | 10 | 120 | 140 | 420 |

### EXAMPLES

An example of a motor or generator made according to an embodiment is provided in FIG. 1 with a stator (2) comprised of 12 stator poles. The stator is formed to a radius fitting the air gap and rotor and to occupy ¼ of the normal stator circumference. This first stator is wound with a common 3-phase scheme typically associated with 14 magnets, sized and spaced to create 42 commutations per revolution. An example of a common 3-phase motor (1) is shown as a reference. The rotor (3) is of such a diameter to house 56 magnets identically sized and spaced to maintain the step commutation requirements of the 12-pole stator. When operated with the enlarged rotor and first stator alone and compared generally with the reference motor, rpm per volt had dropped by 75% and torque had been increased because one, a component part torque constant is determined by the number of magnets passing the stator in a single revolution which in turn increases the number of commutations per revolution in this case by four times. In addition, torque increased naturally with longer distance from the rotor to center shaft.

To describe in a different way, FIG. 1 shows a reference motor stator starting from the normal position occupying the full circumference (1) to a position occupying only a portion (2) or in this embodiment a ¼ segment of the new, four times greater circumference. Accordingly, as seen here, a four times greater circumference is allowed for the rotor (3) allowing a four fold increase in the number of magnets. This large rotor diameter and circumference (compared to the rotor and stator sizes) does not alter the basic size or spacing of the stator poles from the reference design with only minor changes in head shape to fit the new radius and the included angle between stator poles. In other words, a rotor and stator from a smaller motor design can be assembled in groups into a larger motor, according to an embodiment. This preserves the necessary relationships between stator and rotor required for step commutation sequencing and can be maintained as diameters increase.

The changes seen in FIG. 1 are the altering of rpm/v and torque without great impact on IR or other motor constants as in the past. As will be seen in the asymmetrical device of FIG. 1, a change in rotor magnet count effectively reduces the overall rpm/v and increases torque over that of the reference motor design while generally maintaining all other constants. As a consequence of the changes, if the new device were operated at the reference motors design voltage and current limit then rpm would be four times less, torque would be more than four times greater with power (watts) equal to that of the base motor design. This presents the designer with the ability to provide a motor that may not require a gearbox in an application that would normally require one.

In practice, a motor according to this embodiment may have more than one stator combined in parallel, which makes possible a reduction of IR. This allows the designer to set the basic design constants in the first stator and use as many additional stators as is necessary to reach design goals. The rotor diameter and magnet counts become a flexible design element allowing the designer to tailor motors rpm and torque for application. There is no limit to the size and number of magnets in the rotor beyond what is structurally possible and the frequency the material is able to withstand. The only general constraints are that one, the continuous north, south arrangement of magnets be maintained and two, that the magnet size and spacing between magnets be appropriate for stator step commutation.

Table 2 gives minimum and other contemplated rotor pole to stator pole counts, but is not defining a high limit of counts or ratios, as this is no longer a bound relationship.

| Poles per | Rotor Pole | Rotor Pole counts | | | |
|---|---|---|---|---|---|
| 3 | 6 | 10 | 24 | 30 | 36 |
| 4 | 8 | 12 | 16 | 24 | 40 |
| 6 | 12 | 18 | 26 | 38 | 48 |
| 12 | 24 | 36 | 38 | 56 | 66 |

Table 3 gives examples of first stator wiring scheme internal resistance and the effects of additional stators when forming a motor using combined like phase parallel connections.

| First Stator | Total Stators | Motor resistance in |
|---|---|---|
| 0.120 | 2 | 0.060 |
| 0.120 | 4 | 0.030 |
| 0.120 | 10 | 0.012 |
| 0.120 | 20 | 0.0060 |

Desirably, known methods of construction and building and winding large motors can be used, as will be appreciated by a skilled artisan. Additionally, special materials such as thin film soft magnetic materials or amorphous metals are not required as frequencies can be maintained within the capabilities of magnet steels used in laminations.

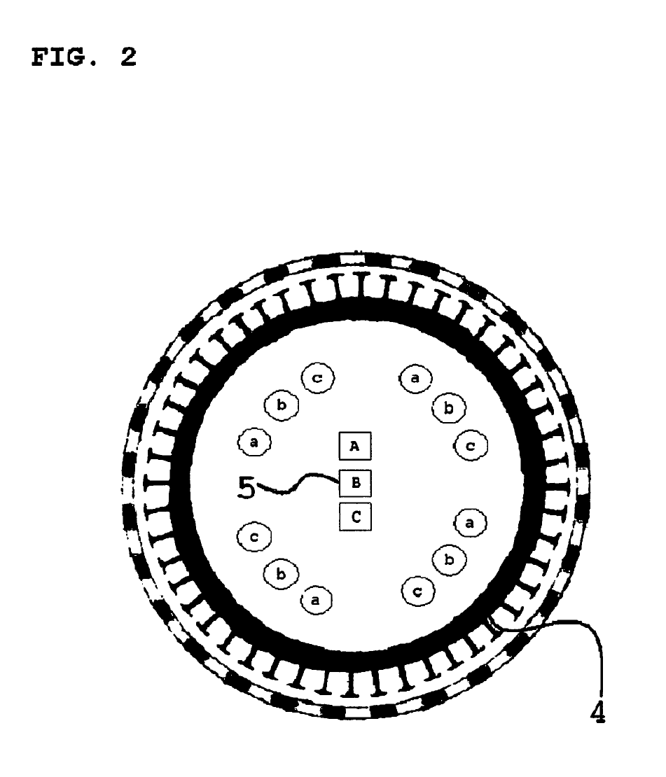

In a preferred embodiment, an individual stator is pre-assembled and used as a module, easily replaced or added to a motor as exemplified in FIG. 2. In particular, as stator pole counts increase with added stators (4), the now symmetrical motors constant IR is reduced due to the like phase parallel connections (5).

This dividing effect from the parallel connections lowers internal resistance and thereby increases efficiency greatly when compared to a conventional motor of equal pole counts, proportions and power. These changes make it possible to increase power without increasing wire diameter, as would be the case with a conventional motor. In particular, it was seen that when two stators were employed, the motor IR was reduced by ½ and as more stators were employed, the reduction continued. To predict this, divide the measured resistance of the first stator by the total number of stators. Additionally, in FIG. 2 torque has increased over the FIG. 1 motor due to the multiplying effect of the added stators. Unlike a conventional motor, the increased load is now shared cross the motors like phase connections in parallel as opposed to being carried by a single motors phase wire connection alone.

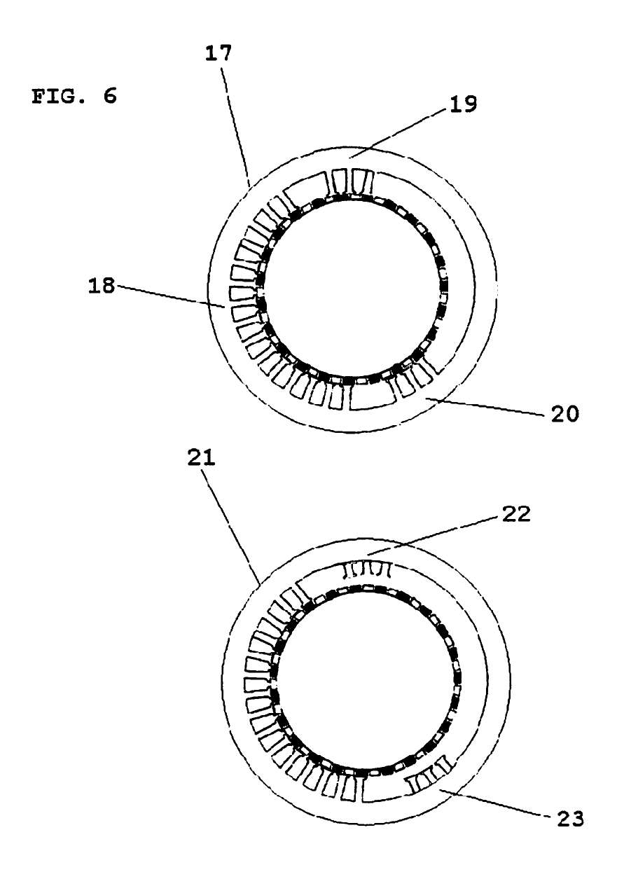

In another preferred embodiment, depicted in FIG. 6. is (17) an interior rotor 3-phase apparatus using 5 stators, 3 poles per stator as the main group (18) with two (19, 20) 3-pole stators mounted on either side of this main group. These are shown in the operating position and are offset such that they are synchronized with the main group. Seen below in (21) is the same apparatus with the stators (22, 23) in a retracted position. This effectively removes the outboard stators from the influence of the rotor and any iron loss associated with them. This variable stator pole ratio option allows the designer to effect torque values while the device is in operation and may involve only 1 or 2 or many more movable stators to effect changes.

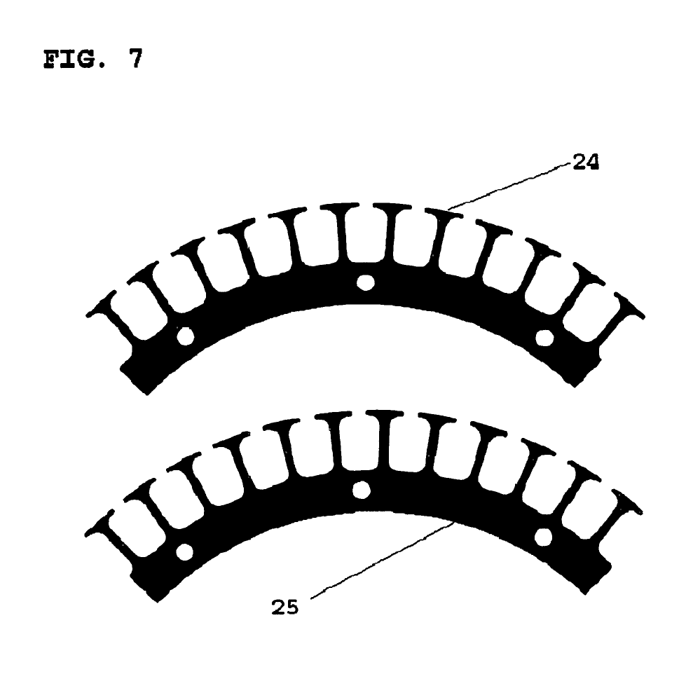

Furthermore, stators treated as modules may simply be removed and replaced with a different, but dimensionally compatible stator, altering the apparatus electrical constants or added to with identical stators to increase power in the application without disassembling the device. To facilitate the module method, a diagram is shown in FIG. 7 as an example only. It depicts two identical stator laminations (24) right side up and (25) flipped over. This order was used to stack the laminations for an asymmetrical module motor and for movable stators. As can be seen in the diagram, the joining area at each end has been altered so as to produce an interleaving effect at each end. This interleaving serves to reduce the adverse effects of iron loss.

An inherent feature in multiple stator devices derived from this construction method is the capability of turning stator(s) on and off at will at the like phase parallel connection. This feature makes it possible to change the output of a motor or generator without removing the device from service. This ability to alter the complete stators configuration in a simple and direct way offers many advantages and options to the designer beyond a single stator motor.

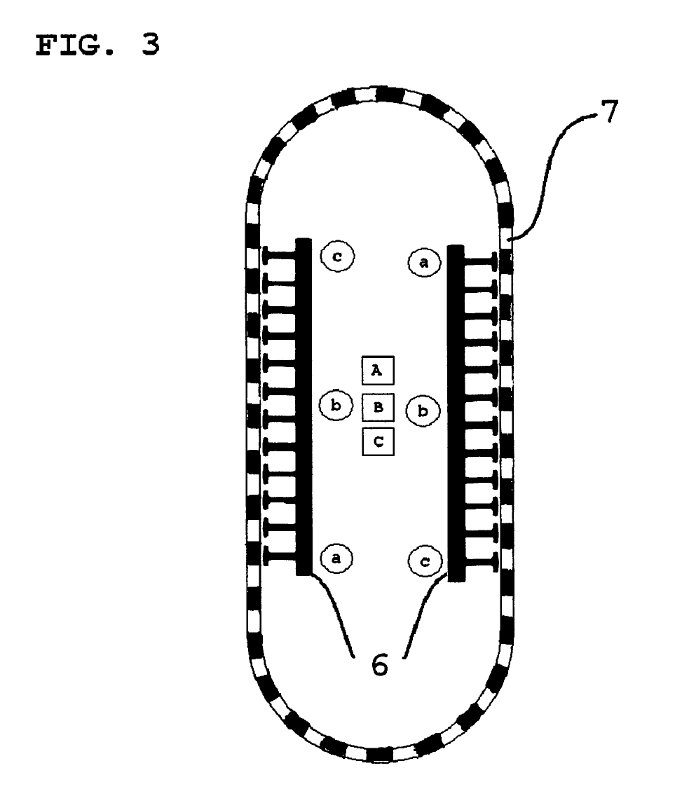

A further embodiment is shown for an odd form apparatus in FIG. 3 and may have many applications. These differ from previous embodiments in that they use of one or more stators (6) with the rotor magnet count driven not by diameter but by application and power requirements (7). Odd Form motors will not have a circular shape or necessarily a uniform distribution of stators. Additionally, they do not use a round rotor but instead use a chain, belt or cable along with the backing iron and magnets to form the rotor and guides to maintain the air gap as the rotor passes a stator(s). The rotors length is determined by application. As before, the magnets forming the rotor need to be sized and spaced in regards to the first stators step commutation requirements and the continuous north, south arrangement.

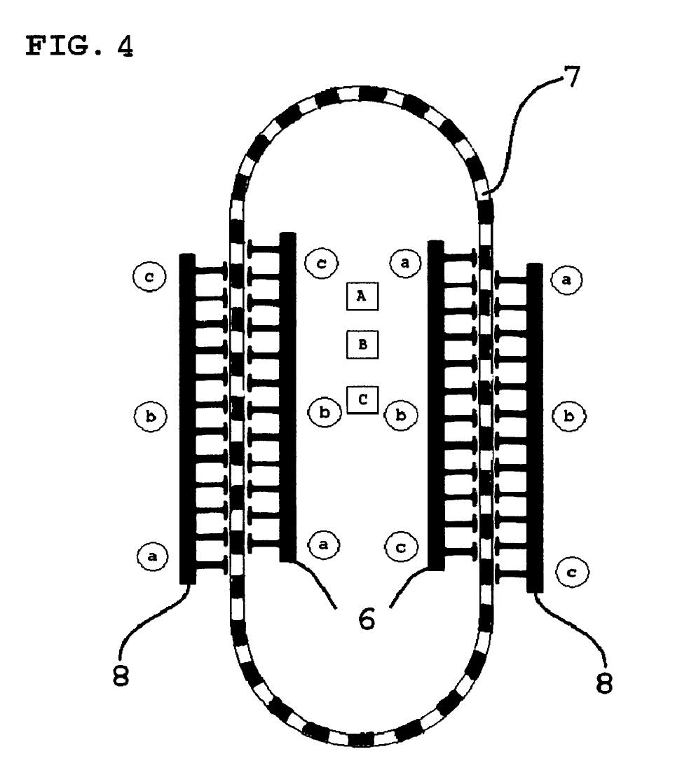

Also seen was the ability to construct the motor/generator in FIG. 4 from the FIG. 3 motor with both interior and exterior stators (8). This motor could operate also as an interior rotor motor if an application required it. In the FIG. 4 embodiment if a chain were used, desirably the rotor would have a second layer of magnets attached or imbedded facing outwardly and the stator(s) desirably are positioned correctly to synchronize commutation between stators. This freedom of design allows many possible shapes to be produced employing both straight or curved stator(s) while having few restrictions in rotor pole length or mechanical configuration.

Performance of both the apparatus in FIG. 3 and FIG. 4 is generally similar to an equivalent asymmetrical motor with the momentum of a spinning rotor transferred to the pulleys or gears used. Benefits of this type of motor or generator may include uses in applications where the motor is part of the device as opposed to a motor being separate and powering a device.

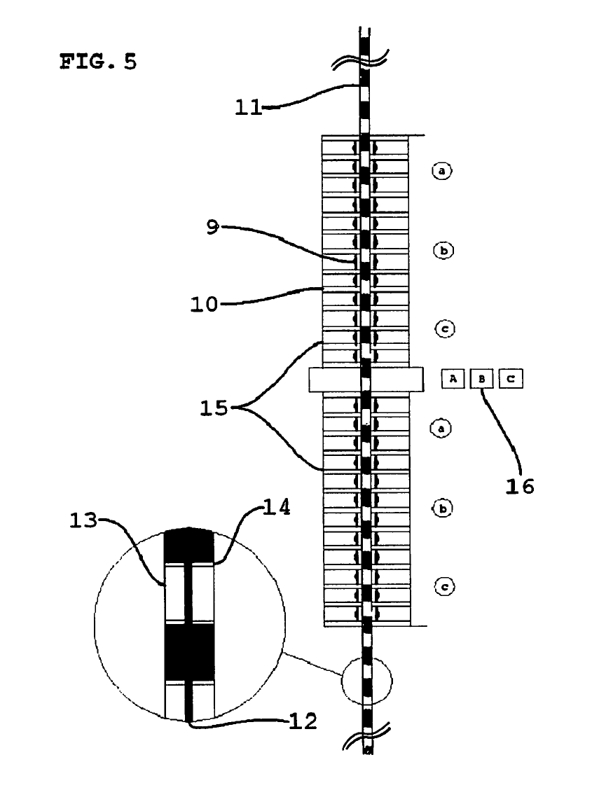

A linear apparatus FIG. 5 is also possible using this method of construction by assembling stacks of circular stators (9) with an open core and spacers (10) between stator to attain stator commutation design requirements. Included is a moving center rod (11) acting as the rotor, constructed of a center steel rod (12) with ring magnets (13) and spacers (14) arranged and sized to give proper commutation sequencing with the sub stator.

Groups of multiple stators (15) can be linked together with like phase connections made in parallel (16). The rotor could be any length required for the application with its only requirement, that the magnets be arranged in the north, south configuration.

This linear motor design mimics the 3-phase reference motor design with the exception of magnet counts and the parallel connected stators phase outputs. The difference and advantages lie in reduced 1R, improved load carrying at output through parallel phase connections, and an increase in active stator and rotor surface areas.

Although the above description focuses on desired embodiments, the same materials and methods are intended for use in other systems and particular motors and generators as well. Other permutations of embodiments will be appreciated by a reading of the specification and are within the scope of the attached claims.

I claim:

1. A multiphase, permanent magnet, exterior rotor, brushless apparatus, comprising:
a complete stator assembly constructed from multiple identical stators wherein each identical stator has poles that are fabricated from permeable steel laminations and insulated copper wire and positioned facing the rotor via an air gap; and
a single enlarged rotor attached to a central shaft with bearings and that rotates about the complete stator assembly, the rotor containing a plurality of alternating magnetic poles formed from rotor pole magnets, that face the complete stator via said air gap, wherein
each stator's like phase output is connected in parallel with that of the other stators.

2. An apparatus as described in claim 1, wherein the apparatus is configured with an interior rotor.

3. An apparatus as described in claim 1, wherein the apparatus is configured as single phase.

4. An apparatus as described in claim 1, wherein the stator assembly that comprises individual stators occupies a volume between 5% to 100% of the interior space of the rotor.

5. An apparatus as described in claim 4, wherein the stator assembly comprises a single individual stator.

6. An apparatus as described in claim 1, wherein the stators of the stator assembly occupy equal portions of the total 360-degree circumference space within the rotor.

7. An apparatus as described in claim 1, wherein each stator group has an identical number of identical stator poles and is wound with an identical wiring scheme.

8. An apparatus as described in claim 1, wherein each stator is formed from stacked magnetic steel laminations, is not formed from thin film soft magnetic materials or amorphous metal, and has a common size and shape.

9. An apparatus as described in claim 1, wherein the rotor pole magnets are dimensioned and positioned for proper first stator step commutation sequencing and wherein a continuous north, south arrangement of magnets is maintained thru the rotor circumference.

10. An apparatus as described in claim 4, wherein less than all of the stators are movably positioned to retract away from the rotors, and thereby alter the torque characteristics of the apparatus during operation.

11. An apparatus as described in claim 4, wherein a complete stator comprises multiple stators constructed as modules, which are removable without disassembly of the apparatus.

12. An apparatus as described in claim 1, wherein the complete stator internal circumference is filled less than 75% by volume.

13. An apparatus as described in claim 1, wherein the rotor inner surface is at least ⅓ foot from the axis of rotation.

14. An apparatus as described in claim 1, wherein the rotor inner surface is at least 3 feet from the axis of rotation.

15. An apparatus as described in claim 1, wherein at least some of the like phase output parallel connections are electrically deactivated, thereby deactivating at least one stator.

16. An apparatus as described in claim 1, wherein the rotor and complete stator are affixed to components of a larger device and held in relationship to each other by the larger device.

17. An apparatus as described in claim 1, wherein the rotor and complete stator are not round.

18. An apparatus as described in claim 4, wherein the ratio of rotor pole magnets to stator poles is at least 2 to 1.

19. An apparatus as described in claim 18, wherein the ratio of rotor pole magnets to stator poles is at least 5 to 1.

20. An apparatus as described in claim 1, wherein the rotor is at least one of a chain, a cable, and a belt.
